(19) United States
(12) Patent Application Publication
(10) Pub. No.: US 2013/0332359 A1
(43) Pub. Date: Dec. 12, 2013

(54) ELECTRONIC PAYMENT ANTI-FRAUDULENT SYSTEM THROUGH REAL-TIME PHONE BASED VERIFICATION CODE

(71) Applicant: Maen Rajab QTEISHAT, Amman (JO)

(72) Inventor: Maen Rajab QTEISHAT, Amman (JO)

(21) Appl. No.: 13/774,662

(22) Filed: Feb. 22, 2013

Related U.S. Application Data
(60) Provisional application No. 61/601,616, filed on Feb. 22, 2012.

(51) Int. Cl. G06Q 20/40

(52) U.S. Cl. CPC G06Q 20/4014
USPC 705/44

(57) ABSTRACT

The Electronic Payment Anti-Fraudulent System through Real-Time Phone based Verification Code is introduced to provide a method or a mechanism to secure the online payments and transactions for both registered online buyers and electronic merchants; this is mainly performed through 2 major sub methods:
1. Identity and Payment Card Owner Ship Verification.
2. Real-Time approval and verification for every online payment or transaction.

This Application claims priority from U.S. Provisional Application Ser. No. 61/601,616 filed Feb. 22, 2012, the disclosure of which is incorporated herein by reference in its entirety.

The Electronic Payment Anti-Fraudulent System through Real-Time Phone based Verification Code is introduced to provide a method or a mechanism to secure the online payments and transactions for both registered online buyers and electronic merchants; this is mainly performed through 2 major sub methods:
1. Identity and Payment Card Owner Ship Verification.
2. Real-Time approval and verification for every online payment or transaction.

### Identity and Payment Card Owner Ship Verification:

This method is designed to verify the registered user identity and to also verify that this user is the real owner for the payment Card which will be used to perform online future payments.

### Real-Time Approval and Verification for Every Online Payment or Transaction:

Every registered user will be issued with 5 Digits PIN linked to his mobile number; and when the user tries to perform online payment and before the real financial transaction takes place; the subscriber mobile number receives a voice call from an IVR (Interactive Voice Response) system informing him that an online payment for x-merchant is just about to take place; and also requiring the registered subscriber to key in his 5 digits PIN through the mobile pad; the user will also be presented with option to reject this online payment if he thinks that the payment card is being used from others for this specific payment; also an option of transferring the Call to the card issuer so his payment card can be stopped in real time will also be provided and offered within the same calling environment.

### Conclusion

If the designed methods can grant that this registered buyer (user) is using his own payment card and also provides methodology that this user has authorized a specific payment via his mobile through typing in his secret PIN; then this will conclude fraud free online payment.

### INVENTION BACKGROUND

Thanks to the internet that has introduced new manner in which merchants' conducts businesses; merchants now a days can conduct online businesses which will enable the offered products and services to have no reach limits and can be delivered and served worldwide.

Regardless this worldwide reach through online trades and businesses; both e-merchants and Payment Card issuers are still suffering from major issues with online fraud caused by scammers who are using payment cards which does not belong to them to purchase products or services.

Chip and PIN technology for example is been presented to the market to sort out part of the problem specifically with the “Card Holder Presence” this security is achieved through getting the payment card holder to insert his Payment Card PIN to a device presented at the POS after which this inserted PIN will be authenticated against the stored one issued by the relevant PSP (Payment Service Provider).

The Electronic Payment Anti-Fraudulent System through Real-Time Phone based Verification Code provides the same level of security for Online Payments with “Card Holder No Presence” with the PIN validation performed directly through the user mobile number with no need for any special devices; the VoIP technology is utilized on this invention to perform the free calling mechanism and also to grant a special dedicated SSL and VPN transportation for the communicated PIN.

The electronic merchants are taking solo responsibilities for charge-backs generated through fraudulent transactions; such secure solution can be adapted and promoted through the e-merchants to minimize the online payments charge-backs caused by fraudulent online payments.

### BRIEF DESCRIPTION OF THE DRAWINGS

FIG. 1 is an exemplary schematic of the overall technique of the present invention.

FIG. 2. Is an exemplary embodiment showing a user registration procedure.

FIG. 3. Is an exemplary embodiment showing a sequence diagram for a genuine buying activity where the registered user himself has performed the activity.

FIG. 4. Is an exemplary embodiment showing a sequence diagram where an illegal buying activity where someone other than the registered user has performed the buying activity.

FIG. 5 shows and exemplary schematic of the mobile and pin invented technology of the present invention.

### THE INVENTION METHODS DESCRIPTION AND DRAWINGS

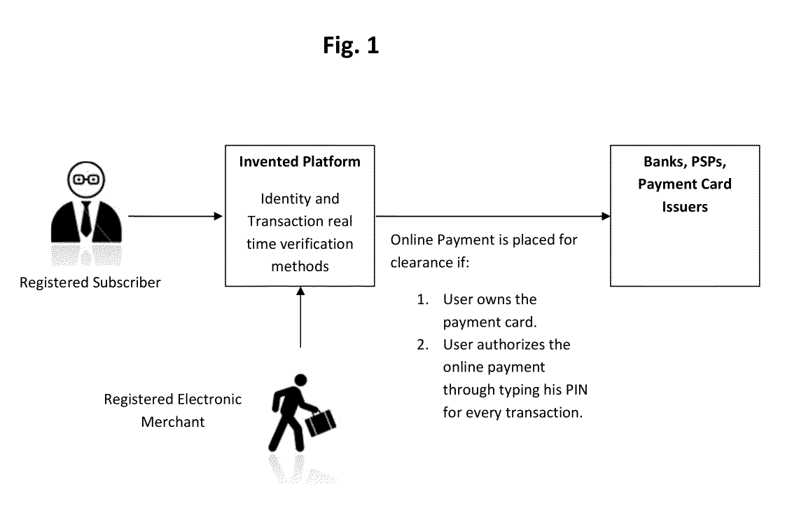

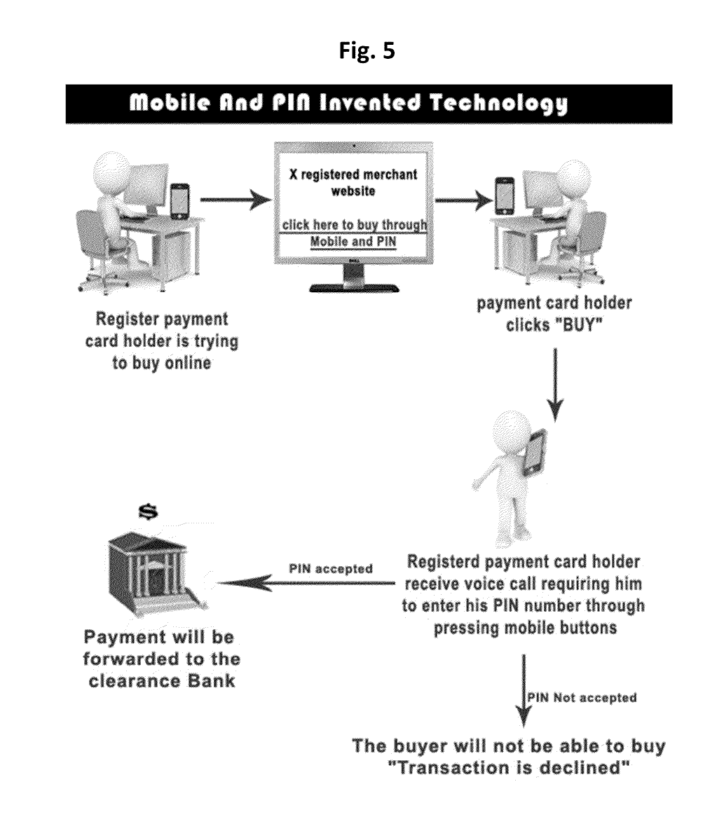

The whole invention is composed of many methods and sub procedures to grant secure online payments and transactions for both the registered users and registered merchants; the system will be composed of registered subscribers, registered electronic merchants and third party APIs provided by the interconnected Payment Service Providers or Payment Card issuers; the system will act as a standalone system dedicated for security; the system task is to verify the user identity and to verify the users approval for the performed online payment prior forwarding the payment for clearance to the relevant payment card issuer or the interconnected PSP (Payment Service Provider)—see FIG. 1 (also see FIG. 5).

### User (Online Buyer) Registration and Identity Verification Procedure:

1. User downloads and installs the mobile application directly from the registered electronic merchant website.
2. User accesses the Signup page available on the mobile application and creates his account through inserting his general personal information including his mobile number (Name, Address etc.)
3. The user account will be created but not activated; to activate the user account; system will send GSM SMS to the user mobile that contains the Activation Key; this way the system is made sure that the provided mobile number is correct and is also accessible by this user.
4. Once the user account is created then to verify the user identity; the user should be presented at the physical address where his payment cards are registered in; and the user should start the following procedure:
   a. User accesses Profile Page available on the mobile app and clicks “Verify me” button; this button will launch both the mobile Cam and the location feature.
   b. User takes photo for his face; after taking the photo it will be unloaded to the system directly and automatically.
   c. User takes photo for his passport; after taking the photo it will be unloaded to the system directly and automatically.
   d. User takes photo for his utility bill; after taking the photo it will be unloaded to the system directly and automatically.
5. System is equipped with a facial recognition system and other systems that will store the following data for the user:
   a. The match between the Face photo and the passport photo; this will be presented in percentage format; the accepted percentages will be pre-defined.
   b. Uploaded photos will provide the user physical address obtained from the location feature.
   c. User address obtained from utility bill photo.
   d. User full name as spelled on his passport.
6. The registered user is ready now to add (register) his first payment card to the system; when the payment card is added a pre defined mathematical rating procedure will be conducted; this procedure will consider the match percentage of the provided face photo and the passport photo; the address of the provided payment card should also match the utility bill address and the address obtained from the location feature; the name appears on the registered payment card should also match the passport name.
7. If all above is correct as described user is said to add (registered) his payment card successfully; user is then issued with the 5 Digits security PIN which will be used on every performed online payment; the PIN will be send via IP SMS directly to his mobile application inbox.

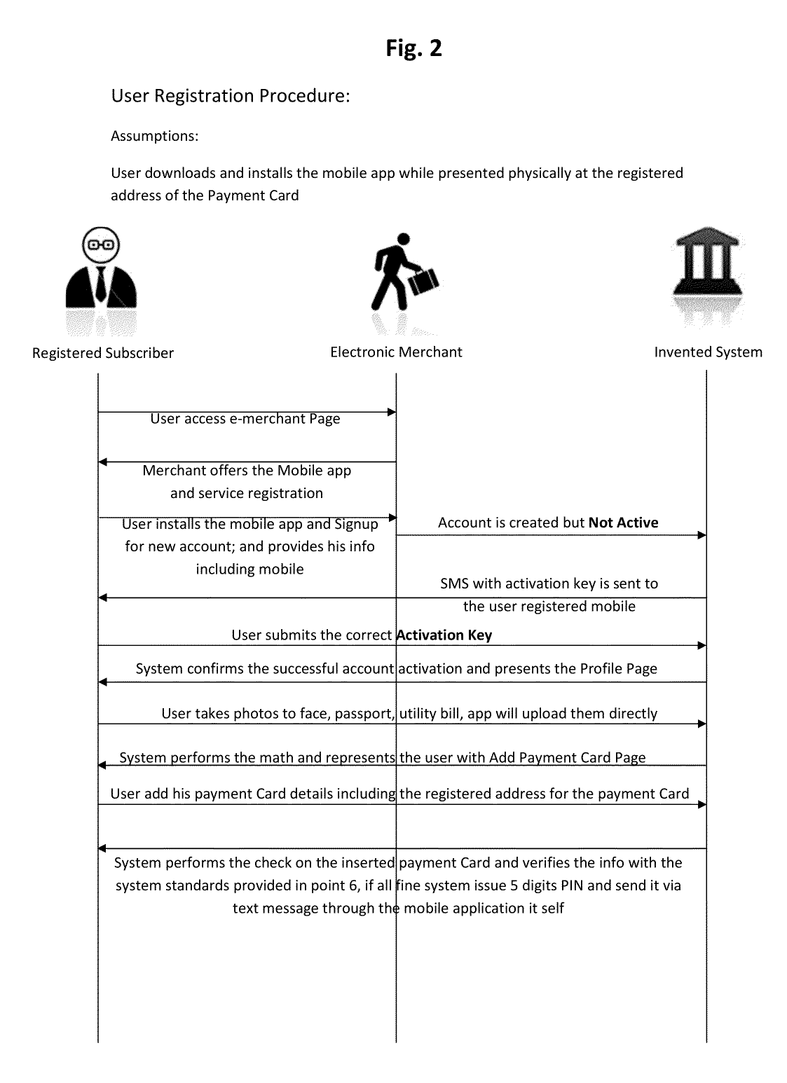

The sequence diagram (FIG. 2) is representing the above procedure—Sequence Diagram (1) (FIG. 2), User Registration Procedure:

### Electronic Merchants Registration:

1. E-Merchant register to the system through providing a simple explanation to his product/service.
2. System provides the e-merchant with the mobile app to be presented at the merchant site and also the invented system will provide the e-merchant with the required API (Application Programming Interface) to integrate to this security invented system and to be able to verify his online buyers before the buying procedure takes place through this invented system.
3. The system API is integrated to the e-merchant commerce website or commerce mobile app; merchant should place the system API before the Payment Card Issuer or Bank API; as this security verification is done in real-time just before placing the online payment for clearance.

### Online Buying and Transaction/Transaction Verification:

1. Registered user accesses the registered electronic merchant POS (website or commerce mobile app).
2. Registered user selects the products/services that he is intended to buy or to pay for and click BUY.
3. The system will place a VoIP call that will transport securely through VPN and SSL to the user mobile and trigger the automated IVR (Interactive Voice Response) and display the bellow voice Message for the user:
“X-Merchant is trying to charge x amount of money to your payment card; if you accept this transaction please insert your PIN number; alternatively press “0” to be transferred right now to the X-Payment Card issuer to stop your payment card if it is not you who performed this online payment.”
4. User inserts the correct PIN; the system will then send this online payment to the Payment Card issuer for the payment to be cleared.
5. If the user declined the transaction through inserting wrong PIN or through pressing other buttons at his mobile pad then the whole transaction will not even reach the Payment Card issuer.
6. If the user received the call while he is sure that it is not him who perform this online payment then user will be able to press “0” at his mobile pad and the call will be transferred directly to his Payment Card issuer to inform him that somebody else is trying to use his payment card so it can get stopped.
The user can provide the Payment Card issuer telephone number during the registration procedure; so the invented system can transfer the call to that specific number.
Sequence diagrams discussed below represent the above mentioned scenario.

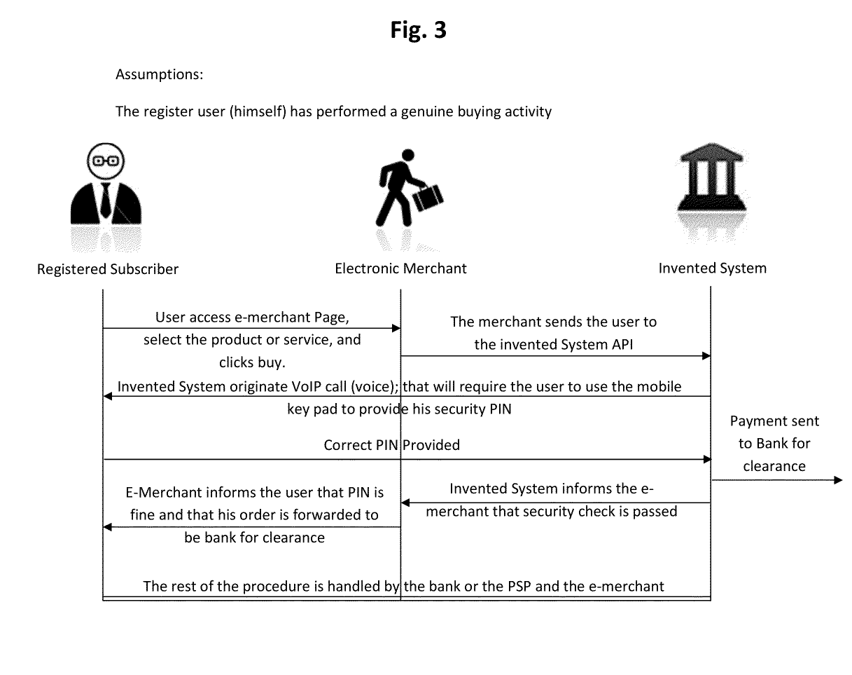

Sequence Diagram (2) (FIG. 3), online buying Procedure:

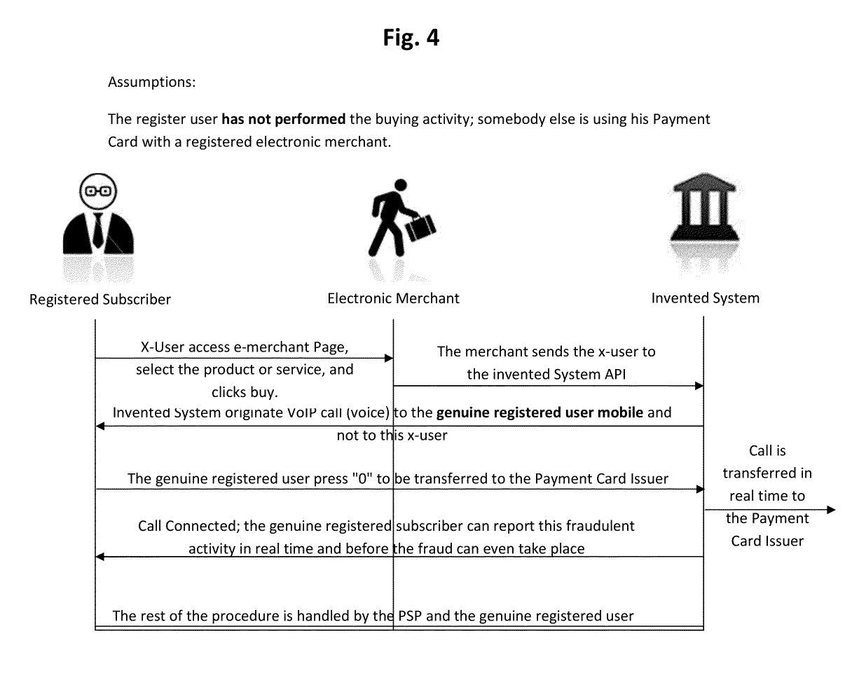

Sequence Diagram (3) (FIG. 4), online buying Procedure:

### Challenges and Debates:

1. Will the e-merchant is still entitled to any future charge-backs?
Answer:
Possibly yes, this invented solution can simply present an evidence to the e-merchant that the user who performed the online buying is genuine and that this user has been presented with a phone call that verified his PIN number and that he did type in a correct PIN number; so this online payment was 100% genuine; after which the e-merchant can present all this info and evidence to the PSP to obtain a refund back and to reverse the charge-back transaction.
2. Who is going to take care of the mobile call charges corresponding to the call verification, Is it the e-merchant or the registered subscriber or payment card holder?”
Answer:
Calls are free as this the whole procedure is utilizing VoIP.

What is claimed is:

1. A method for enabling the (Secure Payment Aggregator—the invented method owners) to verify the identity of the registered user; through getting the user to upload three photos to the system taken and uploaded directly from the user mobile device through an offered mobile application at the same address that matches the address of the registered payment card; the first photo is taken for the user passport; the second photo is taken for user utility bill and the third photo is taken for user face; all photos should be performed with the location feature enabled so photos will reach with the address inserted on them; the address should match the registered payment card address so photos will be instructed to take place at the same location where the payment card is registered; the backend system is equipped with tools to perform the math required to evaluate the face photo and the passport photo match; and also the match of the name on the passport with the name appears on the payment card, and also the provided address for the payment card would be compared to this obtained from utility bill and this obtained through the photos actual location.

2. A method for enabling the registered online buyers to verify every transaction or online payment sent from registered merchants for clearance or settlement before this payment takes place; this is performed through originating an automated voice call which will require the registered user to insert his secret PIN number before presenting this payment card or the online payment to the payment service providers for payment clearance issues.

3. A method enabling the registered subscribers to stop the payment card immediately if fraud is identified; the fraud can be identified if the registered user receives a voice call informing him of a payment that is just about to take place without him initiating this online payment at all; the user will be presented with an option to be transferred immediately to the payment card issuer so this payment card can be stopped.

4. The system of claim 1, further require a mobile application to be installed to the registered user mobile device as the voice call will be performed using VoIP (Voice over Internet Protocol) not GSM operators; therefore SSL and VPN will be the transportation layer for this voice verification call granting the inserted PIN to transport very securely across the network to reach the invented system for the required verification.
